(19) United States
(12) Patent Application Publication
(10) Pub. No.: US 2014/0298358 A1
(43) Pub. Date: Oct. 2, 2014

(54) Method and Apparatus for Providing Optimization Framework for task-Oriented Event Execution

(71) Applicant: NOKIA CORPORATION, ESPOO (FI)

(72) Inventors: Jilei Tian, Beijing (CN); Sailesh Kumar Sathish, Bangalore (IN)

(21) Appl. No.: 14/359,724

(22) PCT Filed: Dec. 14, 2011
(86) PCT No.: PCT/CN2011/083952

§ 371 Date: Jun. 18, 2014

(51) Int. Cl. G06F 9/54

(52) U.S. Cl. CPC G06F 9/542
USPC 719/318

(57) ABSTRACT

An approach is provided for providing an optimization framework for task-oriented event execution. A planner platform processes and/or facilitates a processing of user indication information to determine an event associated with a device, a user of the device, or a combination thereof. The planner platform further causes, at least in part, a creation of a planner object specifying, at least in part, one or more processes related to the event, one or more triggers for the one or more processes, or a combination thereof. The planner platform also causes, at least in part, an execution of the one or more processes at the device, one or more other devices, or a combination thereof based, at least in part, on a monitoring of contextual information against the one or more triggers.

### BACKGROUND

Service providers and device manufacturers (e.g., wireless, cellular, etc.) are continually challenged to deliver value and convenience to consumers by, for example, providing compelling internet services. As economies around the world continue to grow, there is a growing need for less expensive, user intention-based task-oriented event executing, and more affordable devices in newly developing markets. However, such less expensive devices often lack the processing power and capabilities of high-end mobile devices. Consequently, such less expensive devices also may lack the functionality of high-end mobile devices. Moreover, for low-end and high-end mobile devices alike, taking full advantage of the functionality of the devices in, for example, planning an event may be prohibitively complex such that, even with the functionality of high-end devices, the full extent of the available functionality is not used or otherwise distracting. Therefore, as device manufacturers and service providers continue developing mobile devices and network services with increasing functionality, and expand into growing markets, they are continually challenged to make the full extent of the functionality available to all consumers across all types of mobile devices and markets.

### Some Example Embodiments

Therefore, there is a need for an approach for providing an optimization framework for task-oriented event execution.

According to one embodiment, a method comprises processing and/or facilitating a processing of user indication information to determine an event associated with a device, a user of the device, or a combination thereof. The method also comprises causing, at least in part, a creation of a planner object specifying, at least in part, one or more processes related to the event, one or more triggers for the one or more processes, or a combination thereof. The method further comprises causing, at least in part, an execution of the one or more processes at the device, one or more other devices, or a combination thereof based, at least in part, on a monitoring of contextual information against the one or more triggers, on information regarding one or more resources of the device, the one or more other devices, or the combination thereof, on one or more capabilities of the device, the one or more other devices, or the combination thereof, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of user indication information to determine an event associated with a device, a user of the device, or a combination thereof. The apparatus is also caused to create a planner object specifying, at least in part, one or more processes related to the event, one or more triggers for the one or more processes, or a combination thereof. The apparatus is further caused to execute the one or more processes at the device, one or more other devices, or a combination thereof based, at least in part, on a monitoring of contextual information against the one or more triggers, on information regarding one or more resources of the device, the one or more other devices, or the combination thereof, on one or more capabilities of the device, the one or more other devices, or the combination thereof, or a combination thereof.

According to another embodiment, a computer-readable storage medium carries one or more sequences of one or more instructions which, when executed by one or more processors, cause, at least in part, an apparatus to process and/or facilitate a processing of user indication information to determine an event associated with a device, a user of the device, or a combination thereof. The apparatus is also caused to create a planner object specifying, at least in part, one or more processes related to the event, one or more triggers for the one or more processes, or a combination thereof. The apparatus is further caused to execute the one or more processes at the device, one or more other devices, or a combination thereof based, at least in part, on a monitoring of contextual information against the one or more triggers, on information regarding one or more resources of the device, the one or more other devices, or the combination thereof, on one or more capabilities of the device, the one or more other devices, or the combination thereof, or a combination thereof.

According to another embodiment, an apparatus comprises means for processing and/or facilitating a processing of user indication information to determine an event associated with a device, a user of the device, or a combination thereof. The apparatus also comprises means for causing, at least in part, a creation of a planner object specifying, at least in part, one or more processes related to the event, one or more triggers for the one or more processes, or a combination thereof. The apparatus further comprises means for causing, at least in part, an execution of the one or more processes at the device, one or more other devices, or a combination thereof based, at least in part, on a monitoring of contextual information against the one or more triggers, on information regarding one or more resources of the device, the one or more other devices, or the combination thereof, on one or more capabilities of the device, the one or more other devices, or the combination thereof, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 36-38.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing an optimization framework for task-oriented event execution, according to one embodiment;

FIG. 2 is a diagram of the components of a planner platform, according to one embodiment;

FIGS. 3A and 3B are flowcharts of processes for providing optimization for event execution, according to various embodiments;

FIG. 4 is a flowchart of a process for generating a planner object, according to one embodiment;

FIG. 5 is a flowchart of a process for modifying a planner object, according to one embodiment;

FIG. 6 is a flowchart of a process for executing one or more similar processes associated with two or more planner objects, according to one embodiment;

FIGS. 7A-7D are diagrams of user interfaces utilized in the processes of FIGS. 3-6, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for providing an optimization framework for task-oriented event execution optimization framework for task-oriented event execution are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

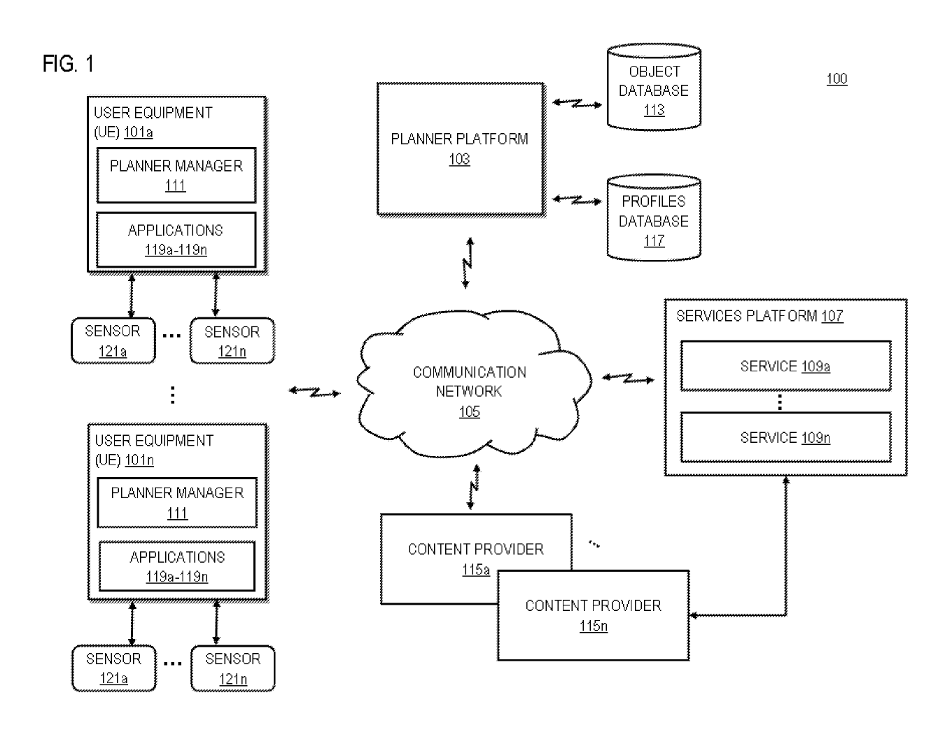

FIG. 1 is a diagram of a system capable of providing an optimization framework for task-oriented event execution optimization framework for task-oriented event execution, according to one embodiment. As discussed above, emerging markets present a volume and growth opportunity. From a market point of view, the low-end mobile device market and growth economies are playing more of dominant role in the mobile device market. Further, following consumer and technical trends, personalized and intelligent applications and services are one of the main topics for future development associated with mobile devices. However, such personalized and intelligent applications and services often rely on high-end devices and/or networks associated with the devices. Thus, a conflict exists between providing low-end devices and networks to new and growing markets while still providing the functionality of personalized and intelligent applications and services.

Further, even considering high-end devices and the networks within established markets that support such high-end devices, services do not currently exist that leverage and combine a wide range of available applications and web services to provide intelligent personal event planning. Rather, such personalized and intelligent applications and services are focused on a single application or a single service basis, rather than, for example, an event that may span several applications and services.

To address this problem, a system 100 of FIG. 1 introduces the capability to provide an optimization framework for task-oriented event execution optimization framework for task-oriented event execution. The system 100 provides intelligent event planning services that leverage and combine a wide range of applications and services across both low-end and/or high-end mobile devices and networks associated with established and/or growing markets. The system 100 provides a smart service solution that may account for a device profile, a user profile, or a combination thereof to intelligently help the user to execute a situation aware event that leverages and combines multiple applications and services, rather than only a single application or service. The system 100 provides a framework that combines user indications, recommendations, data management, network services, contextual information, network and device optimizations to provide a planner interface that is application agnostic. The system 100 provides pre-determined yet adaptive and dynamic changes to utilization management of resources resulting in cost optimization, resource optimization and intelligent service adaptation. The system 100 provides a framework that is compatible with both low-end mobile devices that may be resource-constrained targeted to growth economies, as well as high-end devices targeted to established economies, which allows for both types of devices and the associated users to enjoy cost savings and resource management.

The system 100 provides the capability to process user indication information to determine an event associated with a device, a user of the device, or a combination thereof. In one embodiment, the user may interface with an application and/or a service that indicates the user is interested in performing an event. By way of example, the user may execute an indication at a calendar application by entering an appointment associated with a certain date, time and location that the user is planning an event. Such an example, therefore, may coincide with traveling to the set location at the set date and time. However, the event may be associated with any type of function and/or activity associated directly or indirectly with the device (e.g., use the device as a navigation aid for the trip, use the device to buy an item, etc.).

The system 100 further provides the ability to create a planner object specifying one or more processes related to the event, one or more triggers for the one or more processes, or a combination thereof. The planner object may, for example, indicate temporal and/or spatial constraints with respect to resources and application data management. The planner object may be a rule object that may depend on one or more application types associated with the event for which the planner object is made, as well as user characteristics and device characteristics associated with the event. In one embodiment, the planner object may be a structured XML representation.

The system 100 further provides the ability to execute the one or more processes associated with the planner object at the device associated with the event, one or more other devices, or a combination thereof based on a monitoring of contextual information against the one or more triggers. Thus, once created, the planner object may be managed by the requesting device, managed by one or more other devices, or managed between the requesting device and the one or more other devices. The one or more of the other devices may act as a proxy with respect to the device and the processes associated with performing the event or planning for the event. Accordingly, depending on whether, for example, the requesting device is a low-end device or a high-end device, the planner object may be managed between the requesting device and the proxy to optimize resources of both the device and the proxy. An analysis of the contextual information, the available resources, and the capabilities of, for example, the requesting device and the one or more other devices against the one or more triggers associated with the planner object serve as a basis for where the processes are executed. Further, depending on, for example, the cost of data transmissions between a content provider and/or a service and the device, the data may be transmitted to the device and/or a proxy associated with the device for providing cost optimization (e.g., transmit the data according to known pricing plans).

In one embodiment, the creation of the planner object may be based on a selection by the user of one or more recommendations provided to the user based on the one or more user indications. The system 100 provides the ability to determine one or more user indications indicating what the user would like to do. By way of example, the one or more indications may indicate that the user is traveling at a future date, purchasing a particular item, meeting a person, looking for a home, etc. Upon determining the indication, the system 100 provides the ability to provide one or more recommendations to the user based on optimal heuristics. Upon receiving the one or more recommendations, the user may select one or more of the recommendations. Upon determining the one or more user selections of the recommendations, the system 100 provides the ability to generate a planner object for the event associated with the selection (e.g., planning a trip, purchasing an item, meeting a person, looking for a home, etc.). Thus, rather than generating a planner object based directly on one or more user indications, the system 100 provides the ability to generate one or more planner objects for completing an event based on one or more recommendations that are generated based on the user indications. In one embodiment, the system 100 provides for the ability to use the user profile in determining one or more recommendations based on, for example, behavioral information, preference information, and/or settings information.

In one embodiment, the system 100 provides the ability to determine an optimization object based, at least in part, on the event. The optimization object prescribes how a plan can be made for each event and how to construct the planner object for completing the event. The optimization object may include information pertaining to, for example, what data should be collected to complete an event, where to fetch the data, the applications required to process and/or handle the data, etc. The optimization object includes one or more rules for creating the planner object. The rules may be associated with external services that may be used in completing the task and to which the planner object may instruct the requesting device or one or more other devices to connect to in addressing one or more requirements associated with completing the event. The optimization object may also include one or more rules associated with fetching status data, requirements data, management data, business model data (e.g., payment information), logic description status update data fetch (e.g., such as from a cloud, query and parameter information for status updates, authentication and authorization information, business token information such as agreement tokens between business houses, etc.). In one embodiment, the optimization objects are maintained and provided by the service provider associated with the system 100. However, in one embodiment, external parties may add and modify optimization objects that are owned by the external parties. For example, external parties that provide one or more applications and/or services may provide optimization objects associated with the applications and/or services to the service provider associated with the system 100 so that users may obtain planner objects associated with the applications and/or services based on the optimization objects. In one embodiment, the optimization object may be structured XML objects. The one or more rules associated with the optimization object may also include rules associated with privacy of data used in completing the one or more tasks. By way of example, executing processes at the device rather than one or more other devices may be considered safer and/or more private. Accordingly, the one or more rules of the optimization object may take into account such privacy information.

The system 100 further provides the ability to process and/or facilitate a processing of the one or more rules associated with the optimization object based, at least in part, on the event; at least one device profile, such as a profile of the requesting device, a profile associated with one or more of the other devices, or a combination thereof; at least one user profile; or a combination thereof to generate the planner object. The user profile includes information regarding, for example, behavioral information associated with the user, preference information associated with the user, settings information associated with the user, or a combination thereof. Thus, the planner object may be based on an preference and/or past behavioral aspects of the user with respect to application characteristics (e.g., applications associated with the event, one or more applications associated with a processes, etc.). The planner object may also be based on a device profile that may include information such as one or more resources of the device, one or more capabilities of the device, or a combination thereof. Thus, the planner object may be based on resource and capability information associated with the requesting device and one or more other devices that may, for example, act as one or more proxies for completing the associated event. Because the optimization object includes one or more rules as to how to create the planner object that take into account, for example, the profiles of the devices associated with the event, the created planner objects may be suitable for both low-end and high-end devices.

In one embodiment, the device profiles, the user profiles, or a combination thereof include pricing information with respect for, for example, connections used by the devices to one or more networks. Accordingly, one or more rules associated with the optimization object may be based on an optimization of cost associated with the event and may be based the pricing information associated with the devices profiles and/or the user profiles.

The event may be associated with one or more application categories. The system 100 provides the ability to determine at least one application category associated with the event, associated with accomplishing the event, or a combination thereof and select an optimization object based, at least in part, on the application category. By way of example, where the user is planning a trip, the system 100 provides the ability to select an optimization object based on the application category of trip planning. The associated optimization object includes one or more rules associated with trip planning, such as rules associated with obtaining travel information (e.g., navigational information, planes ticket, rental car, etc.), information regarding places to stay (e.g., hotel information), information regarding places to visit, information regarding when the transmit data correlating to pricing information, etc.

The system 100 provides for the ability to monitor for one or more triggers indicating an initiation of at least one of the one or more processes, a change in at least one of the one or more processes, a completion of at least one of the one or more processes, or a combination thereof. As the one or more processes are initiated, changed, or completed based on the triggers, the system 100 provides for the ability to update the planner object based, at least in part, on the monitoring. By way of example, one or more triggers may occur indicating an initiation of a process and the planner object may be updated accordingly to account for the initiation by focusing on the next process. One or more triggers may occur indicating a change of a process and the planner object may be updated accordingly to account for the change.

In one embodiment, the planner object includes one or more non-automated processes related to an event, and the system 100 provides for the ability to render a presentation of the one or more non-automated processes at the device. The presentations are rendered at the device so that, for example, the user of the device may perform the non-automated actions that are associated with the non-automated processes. The system 100 provides for the ability to monitor for one or more triggers indicating an initiation of the at least one of the one or more non-automated processes, a completion of the at least one of the one or more non-automated processes, or a combination thereof. Based on the monitoring, the system 100 provides for the ability to update the planner object based on the monitoring.

In one embodiment, the system 100 provides for the ability to determine two or more planner objects that include one or more similar processes, identical processes, or a combination thereof. For example, two planner objects may be include the same process of downloading a map associated with a navigation application for providing directions to a destination. In response to the determination, the system 100 provides the ability to combine the two or more planner objects with respect to the similar or identical processes based on the similar or identical processes and execute both of the two processes as a single process. By way of an example, if two processes associated with two planner objects are associated with downloading substantially the same map data for a navigation application, rather than download the map data twice, once for each process, the map data may be downloaded only once and the same map data may be used by the two different planner objects. Accordingly, by combining processes, the system 100 provides for the ability to optimize resources and cost by, for example, only downloading the map information once.

In one embodiment, the system 100 provides the ability to monitor for one or more deviations from the planner object, and process one or more rules associated with the optimization object based, a least in part, on the deviations to update the planner object, generate a new planner object, or a combination thereof. The deviations may include, for example, changes in the contextual information associated with the device, the user of the device, or the combination thereof that exceed one or more thresholds. The deviations may also include, for example, additional user indication information indicating that the event has changed. The monitoring allows for a user to deviate from one or more processes associated with the planner object, and receive an updated and/or new planner object that takes into account for the deviations. By way of example, a planner object associated with an event will have set processes and triggers associated with the processes. A deviation that exceeds a set threshold may affect the one or more processes such that, for example, execution of the one or more processes would be impossible or would not lead to completing the event. Such a deviation may include a change in the arrival location associated with a trip, or a substantial detour while navigating to a final destination. By monitoring for such deviations, the system 100 provides for flexibility in the planner objects and account for deviations.

As shown in FIG. 1, the system 100 comprises user equipment (UE) 101a-101n (collectively referred to as UE 101) having connectivity to the planner platform 103 via a communication network 105. The UE 101 may include one or more applications 119a-119n (collectively referred to as applications 119). The applications 119 may include a navigation application, a calendar application, a web browser application, a contacts list application, a settings application, etc. The applications 119 may provide contextual information associated with the UE 101 and/or the user of the UE 101. For example, the navigation application may provide a location of the UE 101, the calendar application may provide an appointment associated with the user of the UE 101, a contacts list application may provide one or more contacts (e.g., family members, friends, co-workers, etc.) associated with the user of the UE 101, etc. Connected to, or part of, the UE 101 may be one or more sensors 121a-121n (collectively referred to as sensors 121). The sensors 121 may be used to provide additional contextual information associated with the UE 101 and/or the user of the UE 101. For example, the sensors 121 may include a GPS sensor for providing location information associated with the UE 101, a light sensor for providing information regarding the lighting surrounding the UE 101, etc. The UE 101 may also include a planner manager 111. In one embodiment, the functions of the planner platform 103 are embodied on the UE 101 as software and/or hardware modules constituting the planner manager 111, rather than as a standalone element of the system 100.

The system 100 also includes a services platform 107 that includes one or more services 109a-109n (collectively referred to as services 109). The services 109 may encompass navigation services, location-based services, contacts-based services, appointment-based services, or the like. In one embodiment, the services 109 may include one or more proxy services that interact with the planner platform 103 and one or more UE 101 for executing one or more planner objects for completion of one or more events. The system 100 also includes one or more content providers 115a-115n (collectively referred to as content providers 115) that may provide content to one or more services 109 on the services platform 107, to the planner platform 103, and the UE 101. The content may include, for example, one or more applications, one or more information presentations, or a combination thereof. In one embodiment, the content providers 115 may be considered a cloud service that provides content. In one embodiment, the content providers 115 and the services platform 107 may be considered a cloud service that provides both content and services. In one embodiment, all components of the system excluding the UE 101 may be considered a cloud service.

Associated with, or connected to, the planner platform 103 are the object database 113 and the profiles database 117. The object database 113 stores the optimization objects associated with generating one or more planner objects for completing one or more tasks. External parties may access the object database 113 through, for example, one or more services 109 or the planner platform 103 to upload external-party optimization objects for creating one or more planner objects associated with the applications created by the external parties. The profiles database 117 stores the device profiles and the user profiles used by the optimization object to generate and execute the one or more planner objects based on, for example, the capabilities and resources of the devices and the preferences, settings, and behavioral information associated with the user. In one embodiment, the device profiles and user profiles are linked, such that an indication of a device profile/user profile also includes an indication of a user profile/device profile.

By way of example, the communication network 105 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the planner platform 103, the services platform 107, and the content providers 115 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

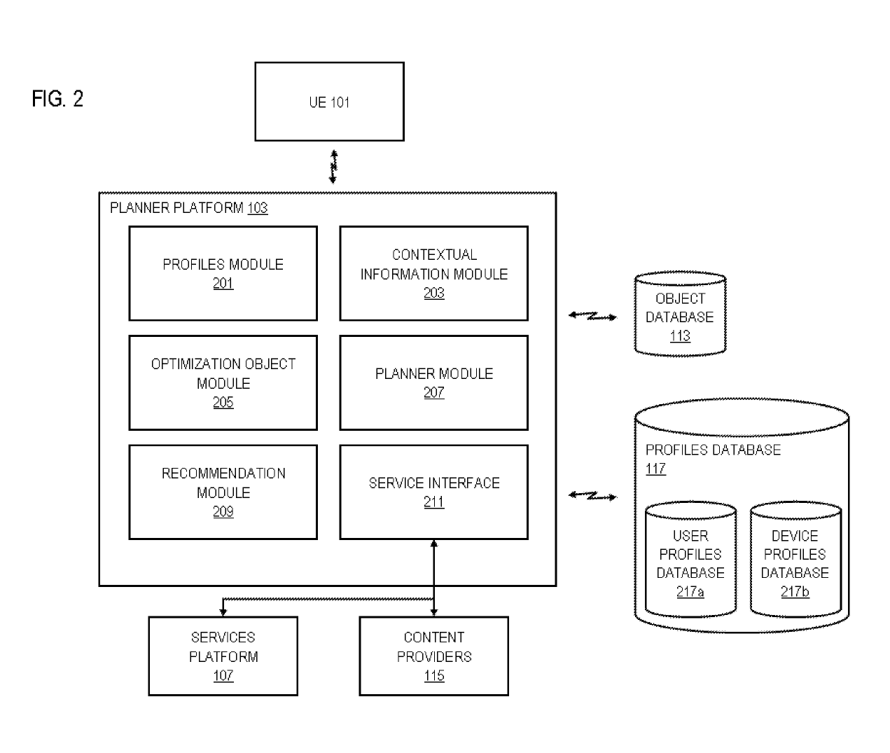

FIG. 2 is a diagram of the components of the planner platform 103, according to one embodiment. By way of example, the planner platform 103 includes one or more components for providing an optimization framework for task-oriented event execution. It is contemplated that the functions of these components may be combined in one or more components or performed by other components of equivalent functionality. By way of example, the UE 101 may include the planner manager 111, which may perform the functions of the components in the planner platform 103. By way of further example, the planner platform 103 and the planner manager 111 may both perform the functions disclosed herein for completing an event in cooperation both at the UE 101 and at the planner platform 103. In this embodiment, the planner platform 103 includes a profiles module 201, a contextual information module 203, an optimization object module 205, a planner module 207, a recommendation module 209, and a service interface 211.

The profiles module 201 associates the user indication information used to generate one or more planner objects for completing an event with one or more user profiles and/or one or more device profiles. Upon receiving user indication information for generating a planner object, the profiles module 201 determines the specific one or more user profiles and/or device profiles that are associated with the request. The profiles module 201 then passes the information regarding what user profiles and device profiles are associated with the user indication information to the other modules of the planner platform 103 for generating one or more planner objects. As discussed above, the profiles database 117 stores information pertaining to the user profiles and the device profiles in the user profiles database 217a and the device profiles database 217b, respectively. The user profiles include information regarding the users, such as behavioral information, preference information, settings information, or a combination thereof. The behavioral information includes past behavioral aspects of the user with respect to the various application categories that may be used in generating a planner object. The preference information includes preference information with respect to various application categories that may be used in generating a planner object. In one embodiment, the user profile may be optional, and where the user profile is not available, the profiles module 201 may rely on general categories of user preference information that may be associated with one or more users. The device profiles include information regarding the resources and the capabilities of the device. The resources of the devices may include, for example, the processing speed, the mount of memory, the amount of storage space, the screen size and/or resolution, etc. The capabilities of the device may include, for example, whether the device supports GPS location services, whether the device supports WiFi connections, etc.

The contextual information module 203 determines the contextual information associated with the devices, the users of the devices, or the combination thereof associated with user indication information used to generate planner objects and used to execute the planner objects. The contextual information module 203 determines the contextual information based on, for example, information received from one or more of the applications 119 and/or the sensors 121. The contextual information may include, for example, location information, temporal information, activity information, navigation information, and the like. The contextual information module 203 passes the determined contextual information to the optimization object module 205 for generating one or more planner objects and/or to the planner module 207 for executing one or more planner objects for completing one or more events.

The optimization object module 205 determines the optimization object used to generate one or more planner objects for completing an event. The optimization object module 205 determines the user indication information associated with a device and determines the event associated with the user indication information. By way of example, the user may enter a reminder in a calendar application executing at the UE 101. Based on the information associated with the reminder (e.g., user indication information), the optimization object module 205 may determine an event associated with the reminder. The optimization object module 205 may further correlate the event with one or more application categories. Upon determining the application category, the optimization object module 205 determines an optimization object that is associated with the application category that can be used to generate one or more planner objects for completing the associated event. The optimization object module 205 retrieves the determined optimization object from the object database 113. The optimization object module 205 subsequently processes one or more rules associated with the selected optimization object based on, for example, the determined event, a device profile, a user profile, contextual information or a combination thereof to generate one or more planner objects. As discussed above, the device profile may be determined from the profiles module 201 based on the device associated with the one or more user indications used to select the application category. Further, the user profile may be determined from the profiles module 201 based on the user associated with the user indication information. Further,

The planner module 207 controls the execution of the one or more planner objects generated by the optimization object module 205. As discussed above, the planner object includes one or more processes related to the event, one or more triggers for the one or more processes, or a combination thereof. The one or more processes related to the event correspond to, for example, one or more actions, one or more tasks, one or more functions, or a combination thereof that are executed in performance of the event. The one or more processes may be executed at the device associated with the user indication information, at one or more other devices (e.g., a service, the planner platform 103, or a combination thereof acting as a proxy), or a combination thereof. By distributing the processes across multiple devices, the system 100 allows for optimization of resources and cost for completing the one or more events. The one or more triggers control the execution of the one or more processes upon, for example, the triggers being satisfied or no longer being satisfied. For example, one or more of the triggers correspond to one or more of the processes such that, for example, when the triggers are satisfied, the one or more associated processes are executed. By way of example, a process may include downloading map information. Based on the device profile associated with the user indication information, downloading the map information may be associated with one process that includes four steps, or four separate processes, that allow for an iterative downloading of the map information that is compatible with the resources associated with the device. The triggers may be associated with the device associated with the user indication information, the planner platform 103, one or more services 109, or a combination thereof.

The planner module 207 determines to download the planner object to the associated device, one or more other devices, one or more services 109 on the services platform 107 (e.g., acting as a proxy service), manage the planner object directly, or a combination thereof. By distributing the planner object between the requesting device and one or more other devices, the resources required to execute the planner object may be distributed to lessen the processing load on any one device. For example, if both the device associated with the user indication information and a proxy manage the planner object, if the device is a low-end device than cannot handle large processing loads, as the load on the device increases, more processing associated with the planner object can be distributed to the proxy. Thus, for low-end devices, the planner object may be managed more by a proxy service or by the planner platform 103 than by the UE 101, and for a high-en device, the planner object may be managed more by the device than by a proxy service. The planner object is managed until the one or more events associated with the planner object have completed or serviced.

In one embodiment, the location where the planner module 207 determines to download the planner object to is dynamic based on, for example, the contextual information, the available resources, and the capabilities of the associated device, one or more other devices, one or more services 109 on the services platform 107, the planner platform 103, or a combination thereof. By way of example, where the associated device is a high-end device that can handle a large processing load, the planner object may be downloaded to the high-end device for execution. However, the processing load of the high-end device may increase as a result of external factors unrelated to the planner object. In which case, despite the device being a high-end device, the device may not be able to effectively execute the planner object. In which case, the planner object may be dynamically uploaded to another device and have the other device execute one or more processes of the planner object.

The planner object may change, be updated, or replaced with a new planner object depending on changes to contextual information associated with the device, the user of the device, or a combination thereof and/or event changes indicated by a user (e.g., through additional user indication information). By way of example, additional user indication information may be received that indicates the current planner object is obsolete based on, for example, changes to the event. Alternatively, changes to the contextual information associated with the device, the user of the device, or a combination thereof may change beyond one or more thresholds such that the planner object is obsolete. Accordingly, the planner module 207 will interface with the optimization object module 205 to generate a new planner object and/or modify the existing planner object.

In one embodiment, rather than generating one or more planner objects based directly on user indication information associated with an indication of an event, the planner platform 103 may use the user indication information to provide one or more recommendations to the user associated with a detected event. By way of example, the user indication information may indicate that the user is planning a trip. Upon receiving the user indication information, the planner platform 103 may generate one or more recommendations associated with planning a trip using the recommendation module 209. Upon presenting the one or more recommendations to the user, and the user selecting one or more of the recommendations, the planner platform 103 may correlate the type of recommendations (e.g., a type associated with the event) to one or more optimization objects, and subsequently generate one or more planner objects for completing the event.

User indication information received by the recommendation module 209 is first mapped to an application category that can service the user indication information. The application categories may be described using an ontology or can be built within service software. By way of example, using an ontology approach allows for extensibility and the ability to open up an interface associated with the planner platform 103 for third party services to update characteristics of applications. The recommendation module 209 may host the application ontology and perform category matching of the user indication information to an application category and identification of application type. The recommendation module 209 then retrieves application heuristics and semantics, identifies the user and/or the user device based on the profiles module 201, retrieves user recommendation data (e.g., collaborative user models) that are appropriate for the application category determined based on the user indication information and outputs a list of recommendations. The recommendations may be generated based on, for example, items versus user ratings (e.g., such as collaborative filtering) or through other well-known recommendation technologies. Upon presenting the list to the user and receiving a selection of one or more recommendations, the planner platform 103 generates the planner object based on the optimization object associated with the application category associated with the recommendation.

In one embodiment, the service interface 211 allows services 109 on the services platform 107 and/or content providers 115 to interface with the planner platform 103 to add (or delete) optimization objects to the planner platform 103 to generate planner objects associated with the services and or content provided by the services 109 and/or the content providers 115. The service interface 211 also allows the services 109 and/or the content providers 115 to interface with the planner platform 103 to modify existing optimization objects registered with the planner platform 103. Thus, the service interface 211 allows third-party service providers to access the planner platform 103 to register optimization objects with the planner platform 103 for generating planner objects associated with the services provided by the third-party service providers.

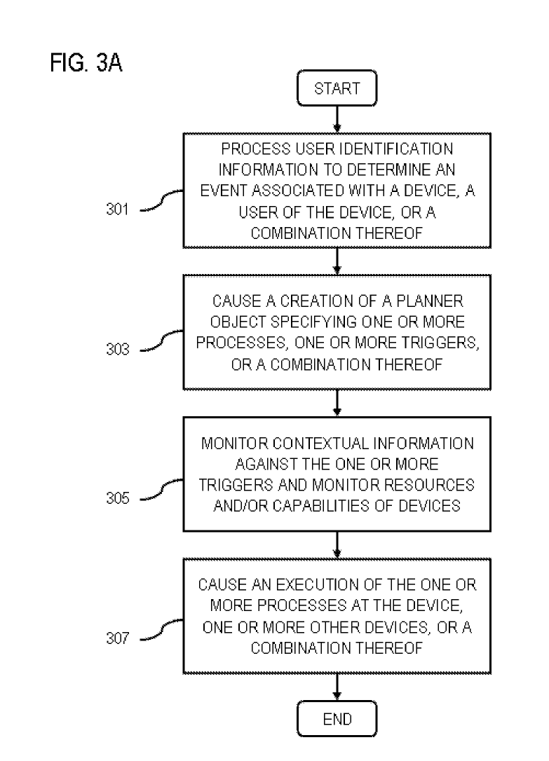

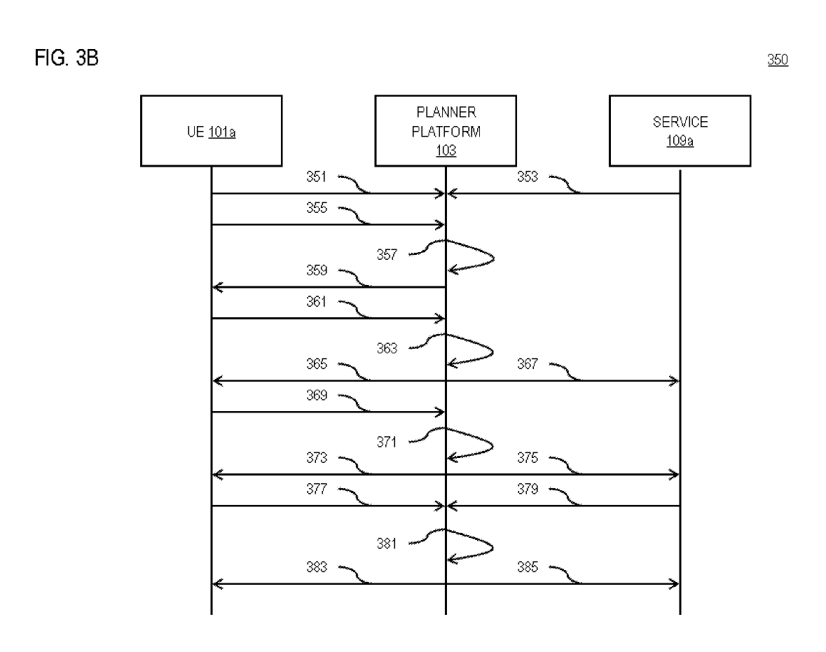

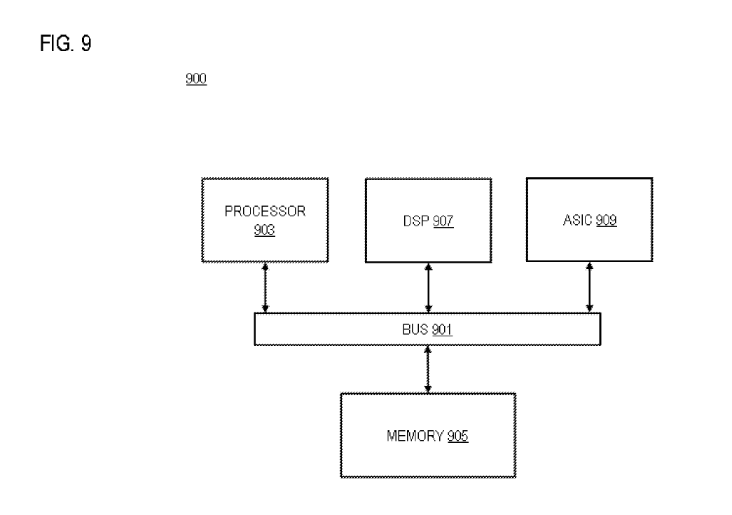

FIG. 3A is a flowchart of a process 300 for providing an optimization for event execution, according to one embodiment. In one embodiment, the planner platform 103 performs the process 300 and is implemented in, for instance, a chip set including a processor and a memory as shown in FIG. 9. In step 301, the planner platform 103 processes user indication information to determine an event associated with a device, a user of the device, or a combination thereof. The user indication information may include any interactions between a user and a device that, for example, indicate the user is planning an event. By way of example, the user may open a browser application to search for flights to a specific city at a specific date, the user may enter appointment information in a calendar application, the user may execute an application to make a purchase, etc. Based on the user indication information, the planner platform 103 determines an event associated with the user indication information. By way of example, the events associated with the above examples may include the trip by way of airplane to the specific city, traveling to a location associated with the appointment information, purchasing an item, respectively.

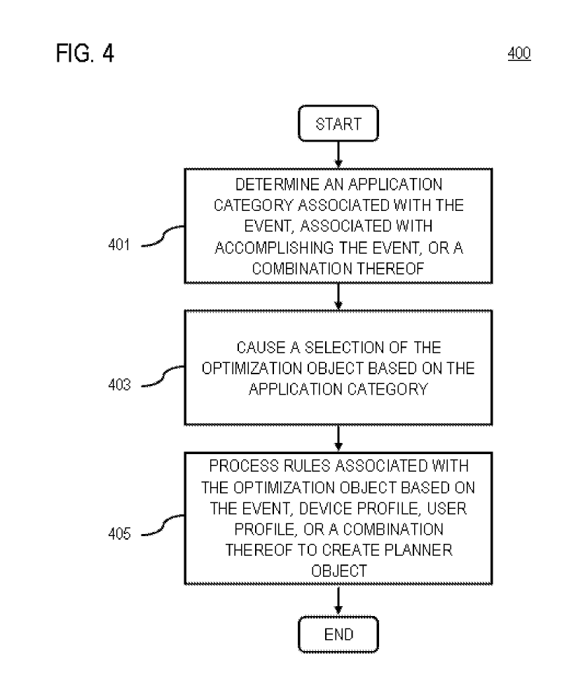

In step 303, the planner platform 103 causes a creation of the planner object based on the user indication information. As discussed above, the user indication information is associated with at least one application category, which is associated with an optimization object. Accordingly, the planner platform 103 processes the optimization object and the associated one or more rules that take into account the event, the user profile, the device profile, or a combination thereof (as discussed below with respect to FIG. 4) to generate one or more planner objects that optimize, for example, resources and cost across one or more devices while completing the event. The planner objects specify one or more processes related to accomplishing the event, one or more triggers associated with the one or more processes, or a combination thereof.

In step 305, the planner platform 103 monitors the contextual information associated with the device associated with the event, the user associated with the device, or a combination thereof against one or more triggers associated with the one or more processes. The triggers may be associated with temporal triggers, spatial triggers, interaction triggers, behavioral triggers that happen at the device side, one or more other devices (e.g., a proxy side, such as the planner platform 103 acting as a proxy), or a combination thereof. By way of example, if a user decides to travel from point A to point C in a week's time, one trigger may be associated with a temporal limitation, such as one day before the travel data that causes a process of downloading map information from point A to point B (e.g., a midway point between points A and C). Another trigger may be associated with a spatial limitation, such as when the associated device reaches point B, to cause a process of downloading map information from point B to point C.

In one embodiment, at step 305, the planner platform 103 further monitors the resources and capabilities of the device associated with the event, one or more other devices (e.g., one or more devices acting as one or more proxies), or a combination thereof for one or more changes in the resources and/or capabilities. By way of example, the planner platform 103 monitors for changes in the resources of the device associated with the event to determine whether the device is able to execute the one or more processes associated with executing the planner object based on the resources of the device. For example, as discussed above, although the device may be a high-end device, other applications executing on the device may increase the processing load beyond acceptable limits for executing one or more processes associated with the planner object at the device. Accordingly, the planner platform 103 may dynamically execute one or more processes associated with the planner platform 103 at the device, at the one or more other devices, or a combination thereof based on the changes in the resources and capabilities of the devices change.

Thus, when one or more of the triggers are satisfied, or no longer satisfied, at step 307 the planner object causes an execution of one or more processes associated with completing the event. Based on one or more rules associated with the optimization object (discussed in detail below with respect to FIG. 4), the processes associated with the triggers are executed at the device associated with the user indication information, one or more other devices or the planner platform 103 (e.g., acting as a proxy), or a combination thereof to optimize resources and cost. Accordingly, functionality of the all types of devices (e.g., low-end devices, high-end devices) across all type of markets and networks (e.g., growing markets, established markets) may be maintained.

FIG. 3B is a detailed flowchart in the form of a sequence diagram of a process 350 for providing an optimization for event execution, according to one embodiment. In one embodiment, the process 350 is performed between a UE 101a, the planner platform 103, and a service 109a acting as a proxy for the UE 101a. Although illustrated in a specific order, the sequences in the sequence diagram may be performed in various different orders.

In step 351, the user of the UE 101a performs one or more actions associated with the UE 101a that represent user indication information. For example, the user may navigate to a website using a browser application at the UE 101a and perform one or more actions that indicate the user would like to perform or complete an event. The user indication information is passed to the planner platform 103 for processing to, for example, determine one or more recommendations associated with achieving the event.

In step 353, in one embodiment, the service 109a registers with the planner platform 103 by, for example, registering one or more optimization objects with the planner platform 103 for generating one or more planner objects associated with a service that is provided by the service 109a. In one embodiment, the service 109a may register with the planner platform 103 as a service that may act as a proxy for one or more UE 101 in executing one or more optimization objects that are associated with other third-party service providers.

In one embodiment, in step 355, the UE 101a also forwards a device profile, a user profile, or a combination thereof to the planner platform 103 so that, for instance, the planner platform 103 can generate one or more recommendations specific for the user of the UE 101a and/or the UE 101a. In one embodiment, the planner platform 103 may retrieve the device profile, the user profile, or the combination thereof from the profiles database 117 that are associated with the user and/or the UE 101a based on, for example, one or more identifiers that are embedded within the user indication information.

In step 357, the planner platform 103 may generate one or more recommendations based on, for example, the user indication information provided to the planner platform 103 in step 351. The planner platform 103 may generate the one or more recommendations based on the received profiles and by using one or more known recommendation techniques (e.g., collaborative user models, etc.). By way of example, the user may want travel to a certain location and may request information regarding what airline to use to travel to the destination, which may be represented by the user indication information and may constitute a desired event that the user would like to accomplish. In response, the planner platform 103 may generate one or more recommendations associated with traveling to the location, such as what airline to use, where to stay, etc.

In step 359, the planner platform 103 forwards the one or more recommendations to the UE 101a for presentation to the user of the UE 101a and to allow the user to select one of the recommendations. In step 361, in response to the user selecting one or more of the presented recommendations, the selected recommendations are forwarded back to the planner platform 103.

Upon receiving the selected one or more recommendations, the planner platform 103, in step 363, determines the application categories associated with the selected recommendations and selects one or more optimization objects associated with the application categories that will accomplish one or more tasks associated with the event. Upon selecting the one or more optimization objects, the planner platform 103 generates one or more planner objects based on the optimization objects. In one embodiment, one optimization object may cover one or more application categories such that only one optimization object is needed to generate one or more planner objects to accomplish the selected event.

In steps 365 and 367, the planner platform 103 uploads the one or more planner objects to the UE 101a, the service 109a acting as a proxy, or a combination thereof for executing one or more processes of the planner object. In one embodiment, at steps 365 and 367, the UE 101a, the service 109a, the planner platform 103, or the combination thereof dynamically instruct the UE 101a, the service 109a, or the combination thereof to execute one or more processes associated with the one or more planner objects based on, for example, the resources and capabilities associated with the UE 101a and the service 109a.

In one embodiment, in step 369, the UE 101a forwards any changes in the contextual information associated with the user, the UE 101a, or the combination thereof to the planner platform 103. In one embodiment, in step 369, the UE 101a may forward any changes in the event (e.g., new user indication information) or updates to the one or more planner objects (e.g., one or more processes that have been completed or that cannot be completed at the UE 101a). By way of example, the UE 101a may upload information regarding a high processing load at the UE 101a such that one or more processes associated with the planner object may be processed by the service 109a rather than the UE 101a. In step 371, the planner platform 103 may make any changes to the planner object as indicated by the forwarded changes. Accordingly, at steps 373 and 375, the planner platform 103 may upload any changes to the planner object and/or one or more processes to be executed at the UE 101a and/or the service 109a in response to the changes forwarded in step 369.

In step 377, the UE 101a may forward information to the planner platform 103 indicating one or more deviations from the planner object that may require modifications to the one or more planner objects and/or new planner objects. By way of example, the UE 101a may forward additional user indication information indicating that the user has changed the event that the previously generated planner object was intended to accomplish. Similarly, in step 379, any services 109 that uploaded the optimization object to the planner platform 103 used to generate the planner object may upload new optimization objects and/or optimization logic (e.g., algorithmic blobs) to the planner platform 103 that may require modifications to the one or more planner objects and/or new planner objects. For example, a new optimization object may indicate that different data is needed to perform one or more processes associated with performing the event.

In step 381, the planner platform 103 may re-compute the planner objects based on the deviations and/or the updated or new optimization objects. In response, in steps 383 and 385, the planner platform 103 may upload the one or more new planner objects to the UE 101a, the service 109a acting as the proxy, or a combination thereof for executing one or more processes based on the new planner objects. In one embodiment, at steps 383 and 385, the UE 101a, the service 109a, the planner platform 103, or the combination thereof dynamically instruct the UE 101a, the service 109a, or the combination thereof to execute one or more processes associated with the one or more new planner objects based on, for example, the resources and capabilities associated with the UE 101a and the service 109a. Accordingly, the process 350 executes until the event is satisfied.

FIG. 4 is a flowchart of a process 400 for generating a planner object, according to one embodiment. In one embodiment, the planner platform 103 performs the process 400 and is implemented in, for instance, a chip set including a processor and a memory as shown in FIG. 9. In step 401, the planner platform 103 determines an application category associated with the event, associated with accomplishing the event, or a combination thereof. As discussed above, the user indication information corresponds to an event. One or more applications may correspond to the event (e.g., a navigation application for navigating to a location), or one or more applications may be used to accomplish the event (e.g., such as a calendar application for processing one or more reminders associated with the event).

In step 403, the planner platform 103 causes a selection of the optimization object based on the application category. As discussed above, the optimization objects are provided to the planner platform 103 from one or more external sources and maintained by the planner platform 103. The external sources have the option to add, remove or modify the optimization objects that are owned by them. Each one of the optimization objects are associated with one or more application categories as defined by, for example, the external source that created the optimization object. Based on the determination of the application category associated with the event, the planner platform 103 correlates the application category to an optimization object and selects the optimization object for generating one or more planner objects.

In step 405, the planner platform 103 processes the one or more rules associated with the optimization object based on the event, the device profile associated with the device, the user profile associated with the user of the device, or a combination thereof to create the planner object. The planner platform 103 processes the one or more rules associated with the optimization object against the device profile and the user profile, which contain the resource information, capabilities information, preference information, and/or behavioral information discussed above, to determine the one or more processes that are to be performed for completing the event, the one or more triggers associated with the processes, and information regarding whether the processes are executed at the device, one or more other devices including the planner platform 103 as a proxy, or a combination thereof to generate the planner object. The planner object includes information pertaining to what information should be fetched to complete the event, where to fetch the information to complete the event, the applications that should be used to complete the event, and a correlation of the acquired information and the applications that should processes the information; the foregoing information based on the one or more rules associated with the optimization object.

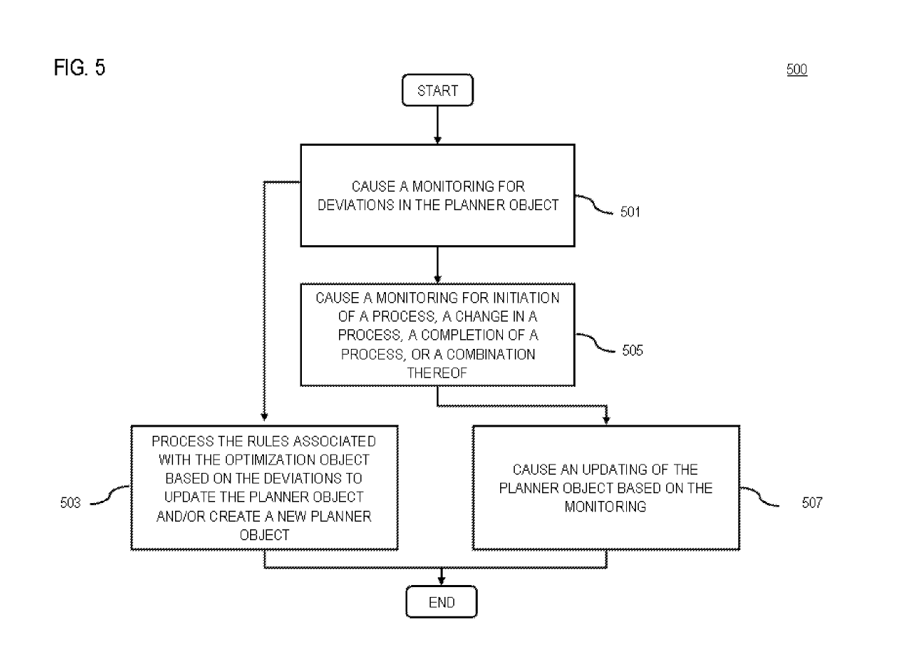

FIG. 5 is a flowchart of a process for providing an optimization for event execution, according to one embodiment. In one embodiment, the planner platform 103 performs the process 500 and is implemented in, for instance, a chip set including a processor and a memory as shown in FIG. 9. In step 501, the planner platform 103 monitors for one or more deviations from the planner object. Deviations in the planner object may represent, for example, additional user indications that a change in the event such that the current planner object will no longer lead to the completion of the event. By way of example, the user associated with the device may perform a search associated with a different trip on the same day as a previously planned trip that has an associated planner object. Deviations in the planner object may also represent, for example, one or more changes in the contextual information that exceed a predetermined threshold. For example, the user associated with the device may follow a detour while following instructions associated with travel information. The detour may correspond to a substantial change in the location of the device (e.g., contextual information) such that a change is required in the planner object. If, in step 501, deviations are detected, the process 500 proceeds to step 503. If, in step 501, deviations are not detected, the process 500 proceeds to step 505.

In step 503, the planner object processes the one or more rules associated with the optimization object according to the new user indication information and/or the new contextual information, against the updated event (if any), the device profile, the user profile, or the combination thereof, and modifies the current planner object and/or generates a new planner object. Thus, the modified planner object and/or the new planner object take into account, for example, the new event associated with the new user indication information and/or the new contextual information that exceeded one or more set thresholds.

In step 505, the planner platform 103 monitors for initiation of a process, a change in a process, a completion of a process, or a combination thereof. The planner platform 103 monitors for one or more triggers that are associated with the initiation, the change, or the completion of the processes associated with the planner object. Upon one or more triggers indicating an initiation of a process, the device and/or one or more other devices that are managing the planner object may determine to execute the process at the device, at one or more other devices (e.g., a proxy), or a combination thereof based on the planner object (e.g., according to the device profile and/or user profile used to create the planner object and/or based on the current resources and/or capabilities of the device and/or the one or more other devices acting as a proxy). By way of example, if a process is initiated that is processing intensive, the process may be executed at a proxy in the event the associated device is a low-end device, or may by dynamically changes to be executed at a proxy in the event that the associated device is a high-end device that is currently experiencing a high processing load. Further, if a process is initiated that involves downloading information, yet the associated device is currently not accessible or currently roaming (e.g., cost is more expensive than normal to transfer the information), the process may be dynamically changed to be executed by the proxy by having the proxy download the information, which can be later transferred to the device when in range or on a different network (e.g., WiFi).

In one embodiment, one or more process associated with completing the event may include rendering a presentation of one or more non-automated processes at the device. By way of example, a trigger may become satisfied indicating that the UE 101 is no longer on the home network. In response, a non-automated process may be triggered presenting such information to the user by way of the display associated with the UE 101 (e.g., an indication that the UE 101 is about to go off of the home network). The presentation may further request, for example, that the antenna associated with the UE 101 be deactivated, which may be a manual process and therefore correspond to a non-automated process.

Upon one or more triggers indicating a change in a process, the planner platform 103 may re-evaluate the one or more processes associated with completing the event and may update the planner object to account for the change in the one or more processes. By way of example, resources of the UE 101 may change based on some other process, independent of the planner object, running on the UE 101 that causes the processing load of the UE 101 to fall below a threshold level. In response, the planner platform 103 may dynamically cause one or more processes currently being executed at the UE 101 for completing the event to be executed at one or more other devices, including the planner platform 103, as one or more proxy devices. By way of a further example, contextual information associated with the device, the user of the device, or the combination thereof may change requiring a change in the planner object (e.g., such as a change in one more of the processes); where the change in the contextual information may not exceed a threshold such that the change is not considered a deviation. By way of example, the planner object may include a process that involves downloading data to the UE 101 at a certain location based on the location having a WiFi connection. However, if at the time the UE 101 is at the location the WiFi is not available, the planner object may adjust accordingly by determining another location to download the data to the UE 101, or by user another device (e.g., a proxy) to download and process the data), thus updating one or more processes associated with the planner object. Upon a monitoring of the initiation, change, and/or completion of the processes, at step 507, the planner object is updated accordingly.

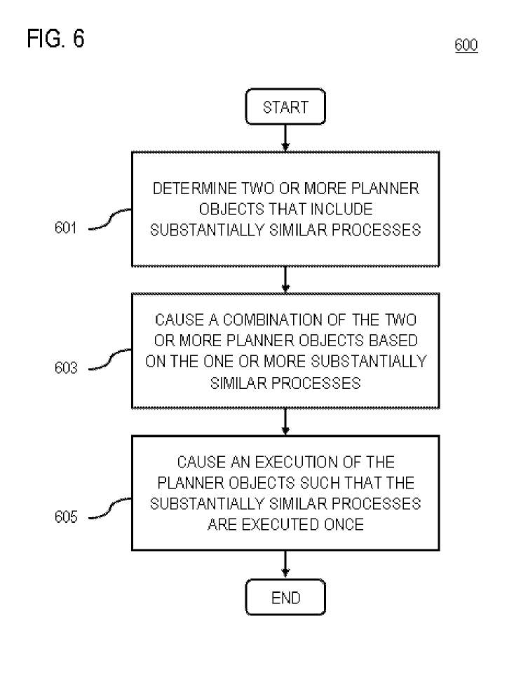

FIG. 6 is a flowchart of a process for providing an optimization for event execution, according to one embodiment. In one embodiment, the planner platform 103 performs the process 600 and is implemented in, for instance, a chip set including a processor and a memory as shown in FIG. 9. In step 601, the planner platform 103 determines there are two or more planner objects that are associated with a single device, a single user, or a combination thereof that include substantially similar processes. Substantially similar processes may include two or more processes where, if one process is performed, the functions and/or object of the other process are performed. By way of example, where two planner objects exist with each one including a process for downloading map information for a specific region, if the specific region for both processes covers the same area, or if one area is larger than the other area, the processes are substantially similar. Executing one of the processes necessarily will execute the other of the processes (e.g., downloading the larger map area necessarily includes the smaller map area of the same region).

In step 603, the planner platform 103 causes a combination of the two or more planner objects with respect to the substantially similar processes. By way of example, the planner platform 103 will update one process not to be executed in anticipation of another process being executed that will accomplish the task of the process.

Based on the combination, in step 605, the planner platform 103 causes an execution of the planner objects such that the substantially similar processes are executed once. In other words, only one of the two processes is executed. By way of example, where map data is downloaded to a UE 101, rather than downloading substantially similar map data twice, once for each planner object as the processes associated with the planner objects call for downloading the map data, the map data is downloaded only once. In doing so, the planner platform 103 may save processing power, memory and storage space associated with the UE 101 and any other associated device (e.g., a proxy).

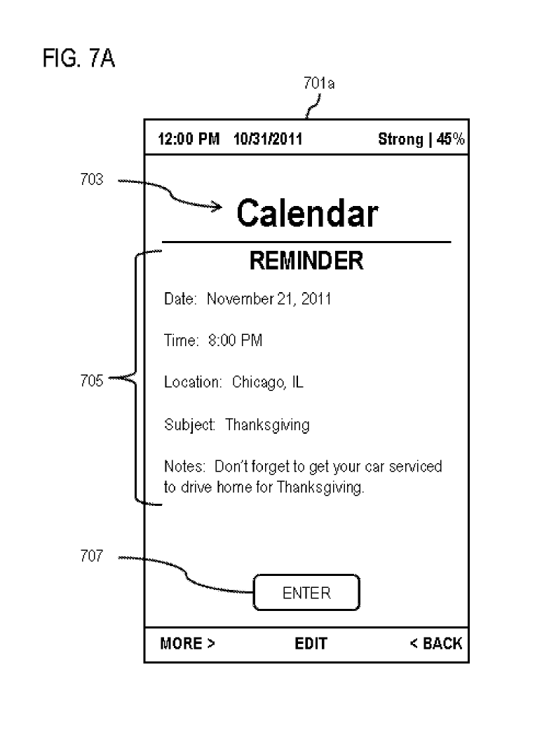

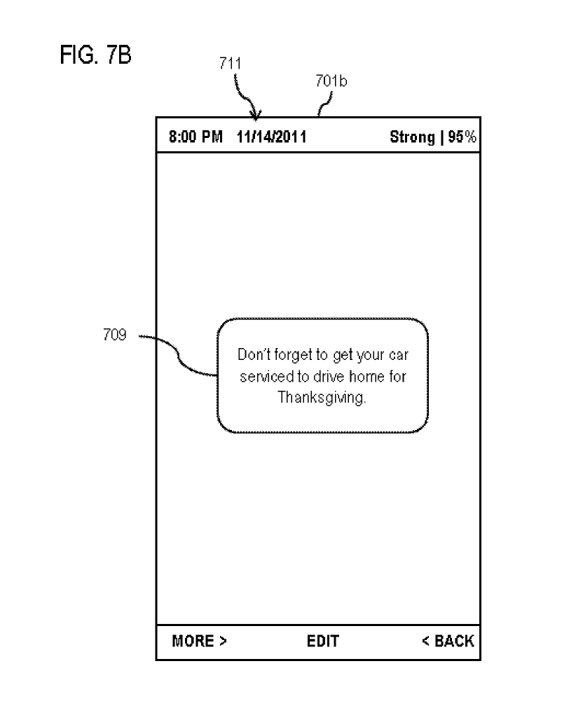

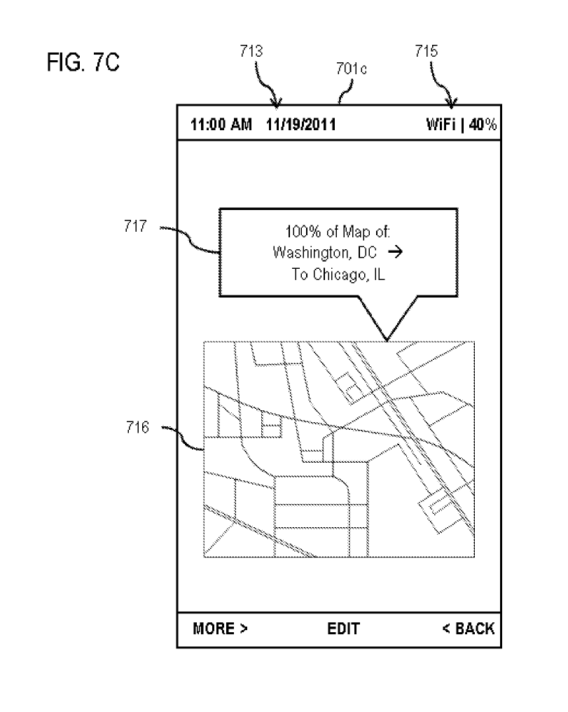

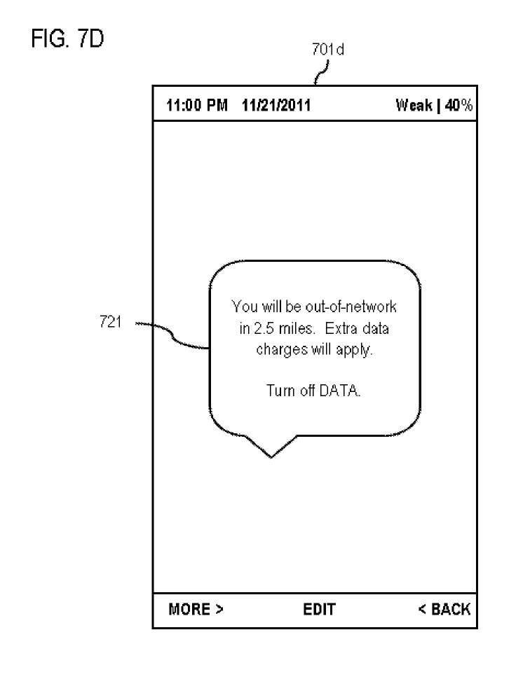

FIGS. 7A-7D are diagrams of user interfaces utilized in the processes of FIGS. 3-6, according to various embodiments. As discussed above, a planner object may be created in response to the planner platform 103 and/or a planner manager 111 processing user indication information to determine an event associated with a device. FIG. 7A illustrates one exemplary embodiment of such user indication information indicating an event. For example, FIG. 7A illustrates the user interface 701a associated with a UE 101a as a user enters reminder information into a calendar application. As illustrated, the user interface 701a includes indicator 703 illustrating that the UE 101a is currently executing a calendar application that allows the user to enter reminder information 705. The reminder information 705 may include, for example, a date (e.g., Nov. 21, 2011), a time (e.g., 8:00 PM), a location (e.g., Chicago, Ill.), a subject (e.g., Thanksgiving), and notes (e.g., Don't forget to get your car serviced to drive home for Thanksgiving). The reminder information 705 user indication information as the user enters all of the reminder information 705. When finished entering the reminder information 705, the user may select indicator 707 to have the calendar application create the reminder. Further, upon selecting the indicator 707 to create the reminder, the planner platform 103 and/or the planner manager 111 may process the reminder information 705 to determine the event associated with the reminder information 705. Based on the exemplary reminder information 705, the event may include a trip to Chicago, Ill. that will occur Nov. 21, 2011, at 8:00 PM. A secondary event, or a related event to the primary event, may also include getting the car serviced to be prepared for the trip. Based on the reminder information 705, one or more planner objects may be created. The planner objects associated with the reminder information 705 may include one or more processes for providing information that may be used to travel to Chicago, Ill., such as map information between the current location of the UE 101a and Chicago, Ill. Thus, the planner object may include one or more processes associated with, for example, retrieving the map information. Depending on the profile of the device, the planner object may include one or more processes associated with downloading the map data. For example, if the UE 101a is a high-end device that has nationwide coverage over a single network, one or more processes may include simply downloading the map information when connected to any network (e.g., WiFi, cellular, etc.). If the UE 101a is a low-end device that has limited network coverage, the one or more processes may be associated with downloading the information in iterative steps of information collection that the mobile device can process, and during times when mobile device is either on the home network, or connected to another, non-metered or unlimited network (e.g., WiFi).

The planner object may also automatically create additional reminders in the calendar application, such as a reminder one or more days before the planned event to have the car serviced. As illustrated in FIG. 7B, the planner object automatically created a reminder 709 associated with the event to remind the user of the UE 101a to have the car serviced to drive home for Thanksgiving. By way of example, the user interface 701b includes the reminder 709. As illustrated by indicator 711, the planner object automatically created the reminder 709 for one week prior to the event.

As discussed above, the planner object generated for the event illustrated in FIG. 7A may include one or more processes for downloading map information to the UE 101a so that, for example, the user of the UE 101a may drive from the current location of the UE 101a to Chicago, Ill. Assuming that the UE 101a is a high-end device (e.g., can receive and process the entire map data information without suffering in processing capability) that is on a limited plan, such data transmission over the designated cellular network is expensive. Accordingly, one or more processes associated with the planner object may include a process to download the entire map information upon the UE 101a connecting to a high speed, non-metered connection, such as WiFi. As illustrated in FIG. 7C, the indicator 713 illustrates the current date and time (e.g., 11:00 AM Nov. 19, 2011). Indicator 715 illustrates that the UE 101a is currently connected to a WiFi network. Assuming that the current date and time is the first time the UE 101a is connected to a WiFi connection since the creation of the planner object, one or more triggers activate causing the UE 101a to download the map information 716. The user interface may also include one or more indicators 717 that present the user of the UE 101a information in the form of a text block 717 regarding the downloading of the map information.

In the event that the UE 101a associated with the user interface 701c is a low-end device, the planner object may include one or more processes that cause the UE 101a and/or one or more other devices associated with the UE 101a to download the map information in smaller sections of information that the low-end device can process without overloading the device. In which case, for example, the planner object may include one or more processes and one or more triggers along the route between the current location of the UE 101a and Chicago, Ill. that indicate that the map information should be transferred to the UE 101a and in what way (e.g., connection type) the information should be transferred.

Similarly to including one or more instructions for how to download the map information to the phone along the route, by way of example, the planner object may include one or more processes that affect the functionality of the phone along the route beyond merely downloading information for completing the event. As illustrated in the example user interface 701d of FIG. 7D, the planner object may include one or more processes for warning the user of the UE 101a of additional charges related to the UE 101a being connected to a non-home network. For example, when the UE 101a is detected as approaching an extended network that includes increased rates, the planner object may include one or more triggers that trigger upon the planner platform 103 and/or planner manager 111 detecting the approaching extended network causing one or more processes to execute rendering the indicator 721 warning the user of the UE 101a of the approaching extended network. Such process may be related to non-automated processes that should be completed by the user of the device. By way of example, that planner object may include a process that renders the indicator 721. However, the action of turning off DATA may be a manual process. Thus, the planner object may warn the user to perform the non-automated process to, for example, avoid additional charges for transmitting data on a non-home network. Turning off DATA may activate one or more triggers updating the planner object that DATA was indeed deactivated.

The processes described herein for providing an optimization framework for task-oriented event execution optimization framework for task-oriented event execution may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

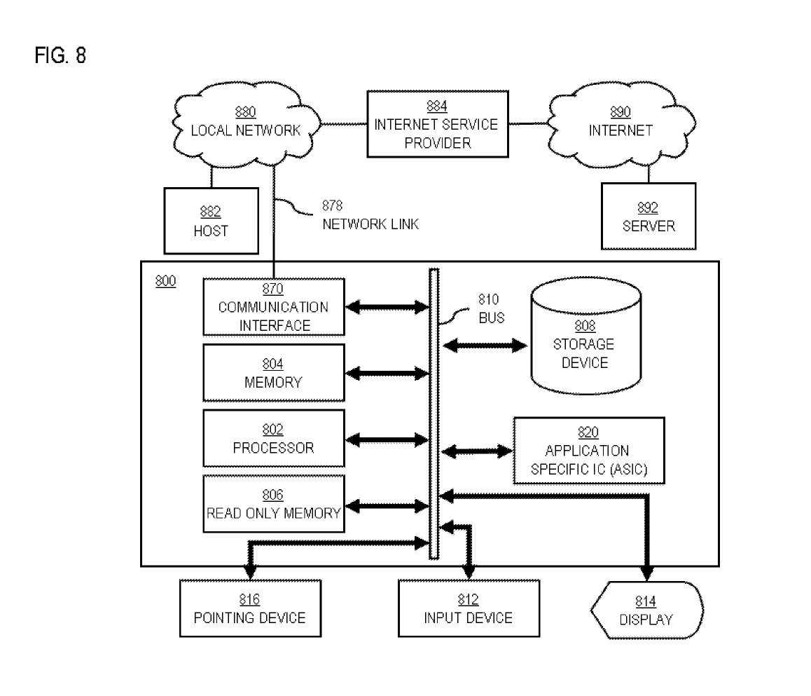

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to provide an optimization framework for task-oriented event execution optimization framework for task-oriented event execution as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of providing an optimization framework for task-oriented event execution optimization framework for task-oriented event execution.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to provide an optimization framework for task-oriented event execution. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for providing an optimization framework for task-oriented event execution. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing an optimization framework for task-oriented event execution, is provided to the bus 810 for use by the processor from an external input device 812, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for providing an optimization framework for task-oriented event execution to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to provide an optimization framework for task-oriented event execution as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of providing an optimization framework for task-oriented event execution.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide an optimization framework for task-oriented event execution. The memory 905 also stores the data associated with or generated by the execution of the inventive steps.

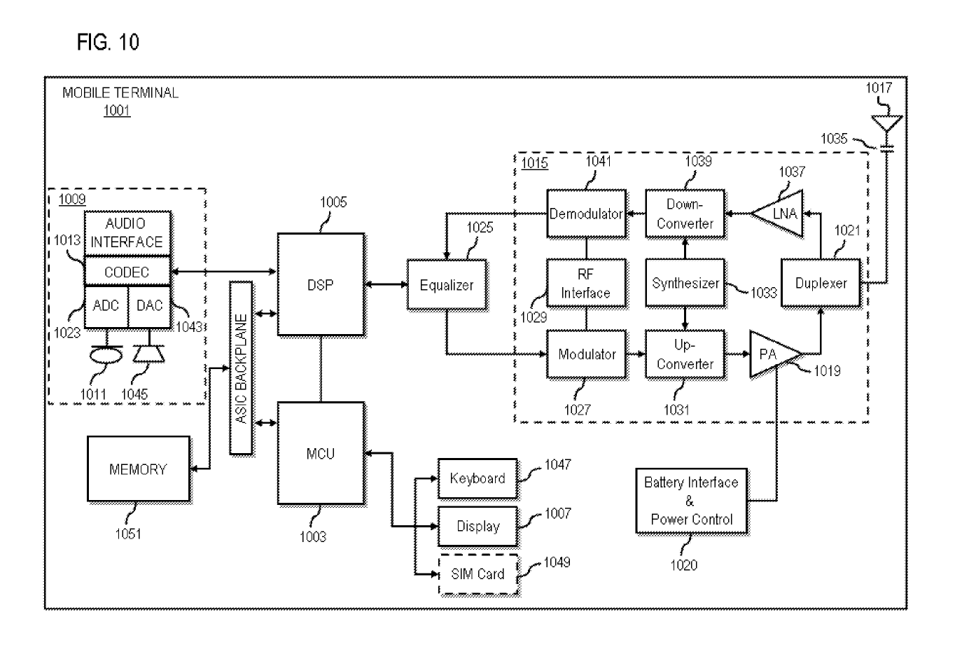

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of providing an optimization framework for task-oriented event execution. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of providing an optimization framework for task-oriented event execution. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to providing an optimization framework for task-oriented event execution. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-38. (canceled)

39. A method comprising:
processing and/or facilitating a processing of user indication information to determine an event associated with a device, a user of the device, or a combination thereof;
causing, at least in part, a creation of a planner object specifying, at least in part, one or more processes related to the event, one or more triggers for the one or more processes, or a combination thereof; and
causing, at least in part, an execution of the one or more processes at the device, one or more other devices, or a combination thereof based, at least in part, on a monitoring of contextual information against the one or more triggers, on information regarding one or more resources of the device, the one or more other devices, or the combination thereof, on one or more capabilities of the device, the one or more other devices, or the combination thereof, or a combination thereof.

40. A method of claim 39, further comprising:
determining an optimization object based, at least in part, on the event; and
processing and/or facilitating a processing of one or more rules associated with the optimization object based, at least in part, on the event, at least one device profile associated with the device, at least one user profile associated with the user, or a combination thereof to generate the planner object.

41. A method of claim 40, further comprising:
determining at least one application category associated with the event, associated with accomplishing the event, or a combination thereof; and
causing, at least in part, a selection of the optimization object based, at least in part, on the at least one application category.

42. A method of claim 40, further comprising:
causing, at least in part, a monitoring for one or more deviations from the planner object; and
processing and/or facilitating a processing of the one or more rules associated with the optimization object based, at least in part, on the deviations to update the planner object, generate a new planner object, or a combination thereof.

43. A method of claim 42, wherein the one or more deviations include changes in the contextual information of the device, the user of the device, or the combination thereof as compared to one or more thresholds.

44. A method of claim 40, wherein at least one user profile includes information regarding behavioral information, preferences information, settings information, or a combination thereof.

45. A method of claim 40, wherein the at least one device profile includes information regarding one or more resources of the device, one or more capabilities of the device, or a combination thereof.

46. A method of claim 39, further comprising:
causing, at least in part, a monitoring for the one or more triggers indicating an initiation of at least one of the one or more processes, a change in at least one of the one or more processes, a completion of at least one of the one or more processes, or a combination thereof; and
causing, at least in part, an updating of the planner object based, at least in part, on the monitoring.

47. A method of claim 39, wherein the planner object comprises one or more non-automated processes related to the event, further comprising:
causing, at least in part, a rendering of a presentation of the one or more non-automated processes at the device;
causing, at least in part, a monitoring for one or more triggers indicating an initiation of at least one of the one or more non-automated processes, a completion of at least one of the one or more non-automated processes, or a combination thereof; and
causing, at least in part, an updating of the planner object based, at least in part, on the monitoring

48. A method of claim 39, further comprising:
determining two or more planner objects that include one or more substantially similar processes; and
causing, at least in part, a combination of the two or more planner objects based, at least in part, on the one or more substantially similar processes,
wherein execution of the two or more planner objects involves executing the one or more similar processes once.

49. An apparatus comprising:
at least one processor; and
at least one memory including computer program code for one or more programs,
the at least one memory and the computer program code configured to, with the at least one processor, cause the apparatus to perform at least the following,
process and/or facilitate a processing of user indication information to determine an event associated with a device, a user of the device, or a combination thereof;
cause, at least in part, a creation of a planner object specifying, at least in part, one or more processes related to the event, one or more triggers for the one or more processes, or a combination thereof; and
cause, at least in part, an execution of the one or more processes at the device, one or more other devices, or a combination thereof based, at least in part, on a monitoring of contextual information against the one or more triggers, on information regarding one or more resources of the device, the one or more other devices, or the combination thereof, on one or more capabilities of the device, the one or more other devices, or the combination thereof, or a combination thereof.

50. An apparatus of claim 49, wherein the apparatus is further caused to:
determine an optimization object based, at least in part, on the event; and
process and/or facilitate a processing of one or more rules associated with the optimization object based, at least in part, on the event, at least one device profile associated with the device, at least one user profile associated with the user, or a combination thereof to generate the planner object.

51. An apparatus of claim 50, wherein the apparatus is further caused to:
determine at least one application category associated with the event, associated with accomplishing the event, or a combination thereof; and
cause, at least in part, a selection of the optimization object based, at least in part, on the at least one application category.

52. An apparatus of claim 50, wherein the apparatus is further caused to:
cause, at least in part, a monitoring for one or more deviations from the planner object; and
process and/or facilitate a processing of the one or more rules associated with the optimization object based, at least in part, on the deviations to update the planner object, generate a new planner object, or a combination thereof.

53. An apparatus of claim 52, wherein the one or more deviations include changes in the contextual information of the device, the user of the device, or the combination thereof as compared to one or more thresholds.

54. An apparatus of claim 50, wherein at least one user profile includes information regarding behavioral information, preferences information, settings information, or a combination thereof.

55. An apparatus of claim 50, wherein the at least one device profile includes information regarding one or more resources of the device, one or more capabilities of the device, or a combination thereof.

56. An apparatus of claim 49, wherein the apparatus is further caused to:
cause, at least in part, a monitoring for the one or more triggers indicating an initiation of at least one of the one or more processes, a change in at least one of the one or more processes, a completion of at least one of the one or more processes, or a combination thereof; and
cause, at least in part, an updating of the planner object based, at least in part, on the monitoring.

57. An apparatus of claim 49, wherein the planner object comprises one or more non-automated processes related to the event, and the apparatus is further caused to:
cause, at least in part, a rendering of a presentation of the one or more non-automated processes at the device;
cause, at least in part, a monitoring for one or more triggers indicating an initiation of at least one of the one or more non-automated processes, a completion of at least one of the one or more non-automated processes, or a combination thereof; and
cause, at least in part, an updating of the planner object based, at least in part, on the monitoring

58. An apparatus of claim 49, wherein the apparatus is further caused to:
determine two or more planner objects that include one or more substantially similar processes; and
cause, at least in part, a combination of the two or more planner objects based, at least in part, on the one or more substantially similar processes,
wherein execution of the two or more planner objects involves executing the one or more similar processes once.
